(19) United States
(12) Patent Application Publication
(10) Pub. No.: US 2020/0394698 A1
(43) Pub. Date: Dec. 17, 2020

(54) DATA PROCESSING SYSTEM AND METHOD FOR RANKING VEHICLES AND TUNING A RANKING ENGINE

(71) Applicant: Fair IP, LLC, Santa Monica, CA (US)

(72) Inventor: Clayton Maxwell Schoeny, Marina Del Rey, CA (US)

(21) Appl. No.: 16/903,096

(22) Filed: Jun. 16, 2020

Related U.S. Application Data
(60) Provisional application No. 62/862,491, filed on Jun. 17, 2019.

(51) Int. Cl. G06Q 30/06; G06F 16/9038

(52) U.S. Cl. CPC G06Q 30/0629; G06F 16/9038; G06Q 30/0641

(57) ABSTRACT

Systems, methods and products for tuning a set of weights for a ranking engine in an automotive data processing system. In one embodiment, a method includes tracking user interactions with an automotive data processing system and identifying, for each user, a corresponding list of vehicles of interest. For each of a plurality of weight sets corresponding to a plurality of ranking factors, vehicles in the user vehicle lists are ranked and scored. The ranking factors include both consumer-facing factors and business-facing factors. These scores are summed to generate an aggregate performance score for the ranking engine using the weight set. This ranking and scoring of the lists and generating an aggregate performance score is repeated for multiple potential weight sets, and the weight set with the best aggregate performance score is implemented as a new working weight set.

### RELATED APPLICATIONS

This application claims priority under 35 U.S.C. § 119(e) to United States Provisional Patent Application No. 62/862,491 filed Jun. 17, 2019, entitled “DATA PROCESSING SYSTEM AND METHOD FOR RANKING VEHICLES AND TUNING A RANKING ENGINE”, which is fully incorporated herein by reference for all purposes.

### TECHNICAL FIELD

The present disclosure relates generally to the field of data processing systems and methods and more particularly to data processing systems and methods for managing interactions between networked computer systems using a rules/machine learning model-based structure that uses a ranking engine to facilitate item transactions.

### BACKGROUND

Internet-based systems and other networked computer systems that facilitate purchasing (buying or leasing) automobiles have become increasingly important tools for both consumers and dealers. For example, vehicle search services provided through the Internet have revolutionized the process of searching for a vehicles. Dealer management systems (DMS) have also become available for the management of finance, sales, parts, inventory and other aspects of running a dealership.

The process of purchasing a vehicle through a dealership typically involves several distinct steps including: i) vehicle search and selection, ii) a test drive, iii) price negotiation, iv) third party loan approval, v) selection of financing and insurance (F&I) options, and vi) document generation and execution. In a typical scenario, a consumer looking to purchase a vehicle wanders dealer lots or uses the various different web sites that may be provided by dealers and third parties to locate vehicles of interest. If the consumer finds a vehicle that they wish to purchase, they will typically have to finance the vehicle and may therefore have to go to a bank or use the bank's web site to apply for a loan. The consumer may alternatively choose to finance the vehicle through the dealer's sales desk or F&I department, in which case the dealer will interact with one or more loan providers to submit loan applications for the consumer.

When the consumer finds a vehicle of interest, the consumer may negotiate a price with the dealer. In some cases, technology may be available to assist the consumer. For example, some third-party vehicle search sites are available that allow consumers to research market prices. This can give the consumer some confidence going into the negotiation, but the negotiated price still typically depends upon back and forth negotiations until, optimally, both the consumer and dealer reach the subjective belief that they came to a fair deal.

The transaction costs for the consumer associated with the purchase of a vehicle may be high, in part because of the various disparate technologies that are used in the vehicle purchase process. As noted above, the consumer typically uses one of a variety of different systems to search for a vehicle and then another system to arrange financing for the purchase, not to mention interactions with the dealer. There is often little or no coordination between these different systems, and the consumer may have to set up separate accounts, provide duplicative information and interact with the systems through different web sites or mobile apps.

The dealer may also have to use various systems to track or otherwise manage sales, finance, parts, service, inventory and back office administration. For instance, the dealer may use a dealer management system that has little or no interaction with inventory search systems or the loan provider systems. Consequently, the dealer may have to enter duplicative information for the consumer into the dealer management system. Similarly, the consumer or dealer may have to coordinate with a loan provider so that the dealer can enter loan information. The lack of coordination between the different systems may lead to breaks in data flow, errors, substantial data duplication and frustration for the consumer. Furthermore, the lack of coordination between systems may make it difficult for the consumer to find a vehicle that both fulfills the consumer's desires and meets the consumer's financial constraints, and may make it difficult, or even impossible, for the consumer to review and understand the details of the purchase before agreeing to final terms.

### SUMMARY

Solutions to one or more of the problems described above may be provided by embodiments of the invention. One embodiment comprises an automotive data processing system for automating and facilitating a purchase process. The system may include components for inventory selection, financing qualification, document generation and the like. In an exemplary embodiment, the system facilitates selection of a vehicle by providing ranked vehicle information to a consumer through an interface on a mobile device. The vehicle information is ranked based on a set of consumer-facing ranking factors and a set of ranking factors that are business-facing and are invisible to the consumer. The consumer-facing factors may include each vehicle's price, the distance from the user to the vehicle's location and an indicator of whether the vehicle is a good deal. The business-facing factors may include an indicator of whether the vehicle represents a good deal for the system operator, adjustments for dealer-related incentives and indicators of dealer responsiveness. The system may track each consumer's interactions with the system through the interface and may maintain a list for each consumer indicating which vehicles have been viewed, which have been marked as “favorites”, or which have been subscribed. For the purpose of this disclosure, “subscribed” refers to a model in which a consumer can register with a service that purchases a vehicle and provides it to the consumer for a monthly fee, which is in some ways similar to a purchase, and in other ways similar to a lease. The system may tune its performance based on the usage information collected from the consumers' interactions. For example, the system may adjust the weights that are associated with the consumer-facing and business-facing factors and simulate the performance of a ranking engine using the adjusted weights as compared to the usage information tracked for the consumers.

One embodiment comprises a method for tuning a set of weights for a ranking engine in an automotive data processing system. The method includes tracking user interactions with an automotive data processing system and identifying, for each of a plurality of users, a corresponding list of vehicles in which the user has indicated interest through the user interactions. For each of a plurality of weight sets, each weight set including a weight corresponding to each of a plurality of ranking factors, the method includes ranking the vehicles in the corresponding list of vehicles for each of the plurality of users using the weight set. For each list of vehicles, a corresponding ranking score is generated. An aggregate performance score for the ranking engine using the weight set is generated based on the ranking scores for the lists of vehicles (e.g., by summing the ranking scores of the lists), and the aggregate performance score is stored with an indication of the corresponding weight set. The aggregate performance scores corresponding to the plurality of weight sets are then compared, and the weight set that has the best corresponding performance is identified. The identified weight set is then implemented as the new working weight set for the ranking engine.

In one embodiment, the ranking factors include one or more consumer-facing factors which are based on information that is visible to users of the automotive data processing system and one or more business-facing factors which are based on information that is not visible to users of the automotive data processing system. For example, the consumer-facing factors may include one or more of a price factor, a location factor and a value factor, while the business-facing factors may include one or more of a deal value factor, a reserved vehicle factor, and a dealer responsiveness factor. The automotive data processing system may present users with a plurality of vehicles (e.g., in an order determined by the ranking engine based on a current working set of factor weights), and may identify for each user a corresponding list of vehicles that the user has either viewed or liked, where the list stores an indication for each vehicle and whether it has been viewed or liked by the user. In one embodiment, the list of vehicles for a user excludes vehicles that have been neither viewed nor liked by the user. The ranking score for each user's list of vehicles may be generated by, for each non-liked vehicle in the list, assigning to the vehicle a point for each liked vehicle in the list which is ranked below the non-liked vehicle, and summing the points for all of the non-liked vehicles in the list. An aggregate performance score for the weight set can then be generated by summing the corresponding ranking scores for all of the users' lists of vehicles.

One alternative embodiment comprises a system having a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a high level block diagram illustrating the structure of an exemplary automotive data processing system topology in accordance with one embodiment.

FIG. 2 is a diagram illustrating components of a ranking engine in accordance with one embodiment.

FIG. 3 is a diagram illustrating sets of consumer-facing and business-facing factors used by a ranking engine in accordance with one embodiment.

FIG. 4 is a flow diagram illustrating an exemplary method for ranking the vehicles in accordance with one embodiment.

FIG. 5 a flow diagram illustrating an exemplary procedure for generating a list of vehicles viewed or liked by a user in accordance with one embodiment.

FIG. 6 a flow diagram illustrating an exemplary procedure for tuning a ranking engine in accordance with one embodiment.

FIG. 7 depicts a diagrammatic representation of a distributed network computing environment.

### DETAILED DESCRIPTION

The invention and various features and advantageous details thereof are explained more fully with reference to the exemplary, and therefore non-limiting, embodiments illustrated in the accompanying drawings and detailed in the following description and appendices. It should be understood, however, that the detailed description and the specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

The present disclosure relates in general to a comprehensive rules/model-based data processing system for automating and facilitating a purchase process, including inventory selection, financing qualification and document generation. In an exemplary embodiment, the system facilitates selection of a vehicle by providing ranked vehicle information to a consumer through an interface on a mobile device. The vehicle information is ranked based on a set of consumer-facing factors (e.g., the vehicle's price, the distance from the user to the vehicle's location and an indicator of whether the vehicle is a good deal), as well as a set of factors that are business-facing and are invisible to the consumer (e.g., an indicator of whether the vehicle represents a good deal for the system operator, dealer-related incentives and dealer performance). The system tracks the consumer's interactions with the system through the interface and, based on the usage information collected from the consumer's interactions, tunes the ranking engine that is used to generate the ranked vehicle information.

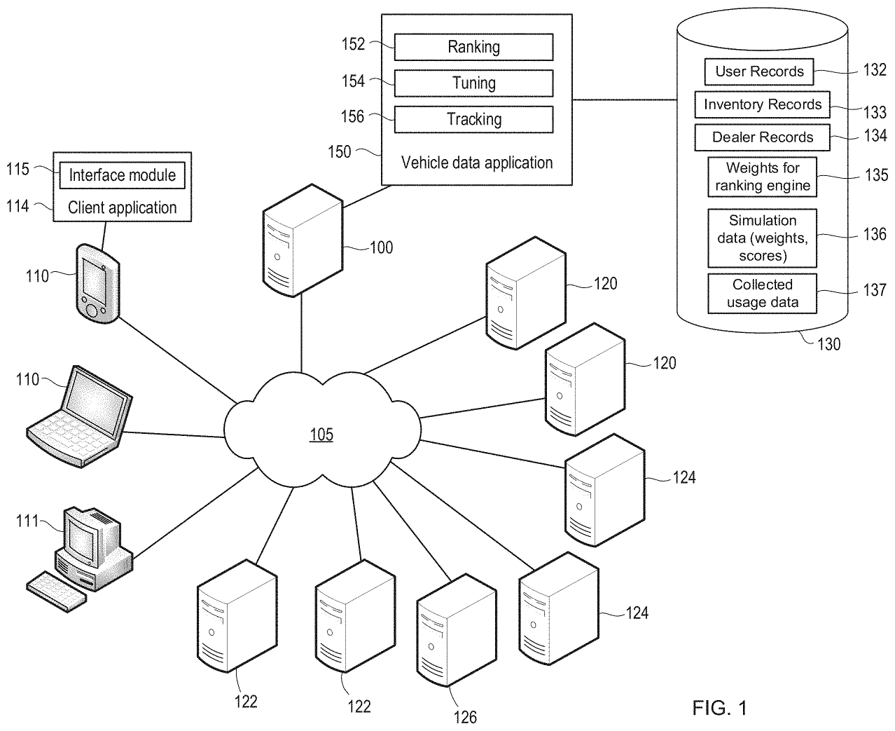

Embodiments of a system for facilitating transactions may be implemented in a network topology. FIG. 1 is a high level block diagram of one embodiment of an example topology. The network topology of FIG. 1 comprises an automotive data processing system 100 which is coupled through network 105 to client computing devices 110 (e.g., computer systems, personal data assistants, smart phones or other client computing devices). Network 105 may be, for example, a wireless or wireline communication network such as the Internet or wide area network (WAN), publicly switched telephone network (PSTN) or any other type of communication link. The system may further include one or more information provider systems 120, one or more dealer management systems (DMS) 122, inventory systems 124, department of motor vehicles (DMV) systems 126 or other systems.

Automotive data processing system 100 may provide a comprehensive computer system for automating and facilitating a purchase process including inventory selection, financing qualification, document generation and transaction finalization, as described in detail in U.S. Patent Application Pub. No. 2018/0204281, which is hereby incorporated by reference. The present disclosure focuses primarily on aspects of the system involving inventory selection, and more particularly components of the system relating to the ranking of displayed inventory items, the tracking of user actions associated with the displayed inventory items, and tuning of the ranking engine that generates the ranking of the displayed inventory items.

Using a client application 114 executing on a client device 110, a consumer user may search dealer inventory, apply for financing, select a vehicle of interest from a dealer and review and execute documents related to the purchase of the vehicle, and execute automated clearing housing (ACH) transactions through automotive data processing system 100 to purchase the vehicle from the dealership. In this context, a “consumer”, is any individual, group of individuals, or business entity seeking to purchase a vehicle (or other asset) via the system 100.

Turning briefly to the various other entities in the topology FIG. 1, dealers may use a dealer management system (“DMS”) 122 to track or otherwise manage sales, finance, parts, service, inventory and back office administration needs. Since many DMS 122 are Active Server Pages (ASP) based, data may be obtained directly from a DMS 122 with a “key” (for example, an ID and Password with set permissions within the DMS 122) that enables data to be retrieved from the DMS 122. Many dealers may also have one or more web sites which may be accessed over network 105, where inventory and pricing data may be presented on those web sites.

Inventory systems 124 may be systems of, for example, one or more inventory polling companies, inventory management companies or listing aggregators which may obtain and store inventory data from one or more of dealers (for example, obtaining such data from DMS 122). Inventory polling companies are typically commissioned by the dealer to pull data from a DMS 122 and format the data for use on websites and by other systems. Inventory systems 124 may provide information on inventory vehicles that is used in the ranking of the vehicles when they are presented to a consumer, such as prices of the vehicles and locations of the vehicles.

DMV systems 126 may collectively include systems for any type of government entity to which a user provides data related to a vehicle. For example, when a user purchases a vehicle it must be registered with the state (for example, DMV, Secretary of State, etc.) for tax and titling purposes. This data typically includes vehicle features (for example, model year, make, model, mileage, etc.) and sales transaction prices for tax purposes. Additionally, DMVs may maintain tax records of used vehicle transactions, inspection, mileages, etc.).

Information provider systems 120 may be systems of entities that provide information used in approving a user or purchase. Examples of information provider systems 120 may include computer systems controlled by credit bureaus, fraud and ID vendors, vehicle data vendors or financial institutions. A financial institution may be any entity such as a bank, savings and loan, credit union, etc. that provides any type of financial services to a participant involved in the purchase of a vehicle. Information provider systems 120 may comprise any number of other various sources accessible over network 105, which may provide other types of desired data, for example, data used in identity verification, fraud detection, credit checks, credit risk predictions, income predictions, affordability determinations, residual value determinations or other processes.

Automotive data processing system 100 utilizes interfaces configured to, for example, receive and respond to queries from users at client computing devices 110, interface with information provider systems 120, DMS 122, inventory systems 124 and DMV systems 126, obtain data from or provide data obtained or determined by automotive data processing system 100 to any of information provider systems 120, DMS 122, inventory systems 124, DMV systems 126. It will be understood that the particular interface utilized in a given context may depend on the functionality being implemented by automotive data processing system 100, the type of network utilized to communicate with any particular entity, the type of data to be obtained or presented, the time interval at which data is obtained from the entities, the types of systems utilized at the various entities, etc. Thus, these interfaces may include, for example, web pages, web services, a data entry or database application to which data can be entered or otherwise accessed by an operator, APIs, libraries or other type of interface which it is desired to utilize in a particular context.

Vehicle data application 150 can comprise a set of processing modules or engines to process obtained data or processed data to generate further processed data. Different combinations of hardware, software, and/or firmware may be provided to enable interconnection between different modules of the system to provide for the obtaining of input information, processing of information and generating outputs.

In the embodiment of FIG. 1, vehicle data application 150 includes a ranking module 152, a tuning module 154 and a tracking module 156. Ranking module 152 receives various input signals associated with factors involved in determining an order in which vehicles may be presented to a consumer, as well as a set of weights associated with the different factors or signals, and generates the vehicle order based on these signals and weights. The input signals to ranking module 152 may be retrieved from, or generated based upon, various data records persisted in data store 130, such as user records 132, inventory records 133, and dealer records 134. The input signals received by ranking module 152 are weighted using weights 135 that are persisted in data store 130.

Tuning module 154 enables the periodic adjustment of the weights used by ranking module 152 in order to tune the operation of the ranking module to improve its performance in predicting which vehicles the consumer is most likely to purchase. Tracking module 156 receives input from a user application running on the consumer's client device and uses this input to track the consumer's interactions with the application in relation to ranked displayed vehicles. The tracked information 137 is stored in data store 130, and is used by tuning module 154 and ranking module 152 to simulate the ranking of vehicles previously viewed by the consumer using tentative sets of weights and then scoring the performance of the tentative sets of weights according to the interest in the vehicles expressed by the consumer through the tracked interactions. The tentative sets of weights and the corresponding scores 136 are stored in data store 130. The best-performing tentative set of weights can then be saved in place of the previous weights 135, and the new weights are used by ranking module 152 going forward to generate rankings of vehicles.

Vehicle data application 150 may also include various other modules which are not described in detail herein. These modules may include, for example, dealer interaction modules, user interaction modules, inventory modules, order modules, financing modules, document modules, and various other modules that may be necessary or desirable to perform the functions of the vehicle data application.

Client computing devices 110, 111 may comprise one or more computer systems with central processing units executing instructions embodied on one or more computer readable media where the instructions are configured to interface with automotive data processing system 100. A client computing device 110, 111 may comprise, for example, a desktop, laptop, smart phone or other device. According to one embodiment, a client computing device 110 is a mobile device that has a touchscreen display and relies on a virtual keyboard for consumer data input. Client application 114 may be a mobile application (“mobile app”) that runs in a mobile operating system (e.g., Android OS, iOS), and is specifically configured to interface with automotive data processing system 100 to generate application pages for display to a consumer. In another embodiment, the client application 114 may be a web browser on a desktop computer or mobile device. A client computing device 111 may run an application through which a dealer portal can be accessed.

In accordance with one embodiment, a consumer can utilize client application 114 to register with automotive data processing system 100, view inventory, select a vehicle, apply for financing, review documents and finalize a sales transaction through a low friction mobile app running on a smart phone. Client application 114 can be configured with an interface module 115 to communicate data to/from automotive data processing system 100 and generate a user interface for inputting one or more pieces of information or displaying information received from automotive data processing system 100. In some embodiments, the application 114 may comprise a set of application pages through which application 114 collects information from the consumer or which client application 114 populates with data provided via an interface 160. Application 114 may collect information that is manually input by the consumer so that it can be processed by automotive data processing system 100 with other information associated with the consumer. This information can be used to determine, for example, the consumer's qualification for a vehicle purchase, financing options available to the consumer, or pricing for particular vehicles. Application 114 may also collect automatically information associated with the consumer's views of displayed vehicles and identification of particular vehicles as favorites or subscribed vehicles. This information may be used to tune the weights that are applied to signals input to a ranking engine that determines an order in which vehicles are displayed to the consumer.

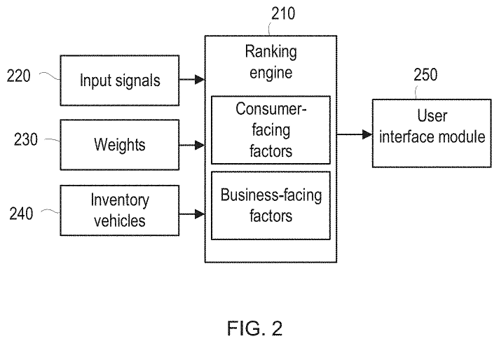

Referring to FIG. 2, a diagram illustrating components of a ranking module or ranking engine in accordance with one embodiment is shown. In this embodiment, the ranking module has a ranking engine 210 that is configured to receive input signals 220 and associated weights 230, and to generate rankings for vehicles 240 that are provided to a user interface module 250. Input signals 220 take into account different categories or types of factors that affect the rankings. Some of these factors are consumer-facing (i.e., the consumer can see the associated factors or values with which they are associated), while other factors are business-facing (i.e., the consumer does not see the factors or the values associated with these categories). Each of the individual categories has an associated weight which is used as a multiplier for the category.

In one embodiment, the functions for the ranking categories are individually applied to each vehicle in a selected pool. This pool of vehicles is normally a subset of the larger set of inventory vehicles, where the subset may be determined by filtering the larger set of vehicles. The filtering of the inventory of vehicles is not essential, but it can be used to define the universe of cars that the user can see and consequently the set of cars that will be ranked. There are a number of filters that the user can set while shopping, including but not limited to: price range; maximum distance to the user; maximum mileage on the vehicle's odometer; color of the vehicle; model year of the vehicle; and specific brands or models. These filter's do not affect the ranking algorithm itself.

The factors as applied to each vehicle are multiplied by the corresponding weights to generate contributions for the vehicle for the respective categories. The contributions of each of the categories for the vehicle are summed to produce a value for the vehicle. The total of the category values for each vehicle in the selected pool is then used as the basis for ranking the pool of vehicles.

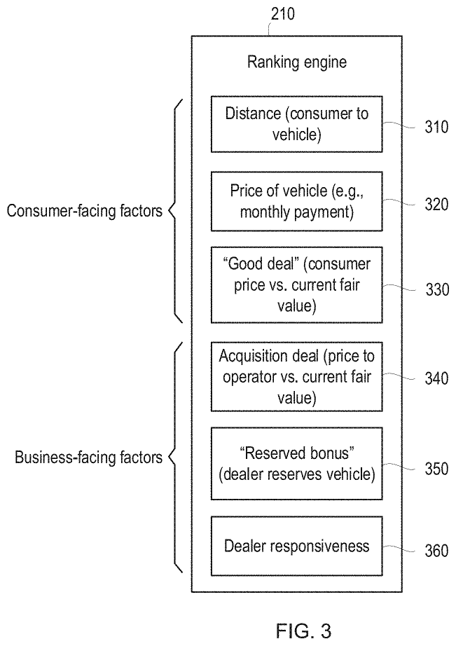

As noted above, the categories in this embodiment include a set of consumer-facing categories and a set of business-facing categories. The categories in one embodiment are illustrated in FIG. 3. The consumer-facing categories in this embodiment correspond to distance (between the vehicle and the consumer), price (e.g., total purchase price or initial/monthly payments), and value (whether the vehicle is a “good deal” as determined by, e.g., the price of the vehicle divided by a “fair value” of the vehicle). The business-facing categories in this embodiment correspond to value (whether the vehicle price is a good deal for the system operator as determined by. e.g., acquisition price divided by fair value), reserved vehicle bonus (an incentive bonus associated with a dealer of the vehicle), and a dealer score (a measure of the responsiveness of the dealer of the vehicle). It should be noted that these categories are intended to be illustrative of the different types of categories that could be employed, and should not be construed as limiting.

The first consumer-facing category 310 in this embodiment is based on the distance between the consumer and the vehicle. The input signals for the category include the location of the vehicle and the location of the consumer. The location of the vehicle is known from the inventory information (e.g., the location of the dealer of the vehicle) and may be extracted from the inventory records that the system has previously received and stored in an associated data store. The location of the consumer may be determined in any of several different ways. For example, the consumer may have explicitly provided location information when searching for vehicles (i.e., a city in which to search for vehicles). Location information may also be explicitly provided when registering with the system, so it may be retrieved from a data store connected to the system. Alternatively, the consumer's location may be derived from information contained in communications between the consumer and the automotive data processing system. For instance, the consumer may be able to select an option (e.g., “search near me”) in which they give the system permission to use the physical location of the user's mobile device. The communications from the consumer may also contain indications of their origin (e.g., IP address) which can be associated by the system with a particular geographic location or region.

The signal score for the distance category in this embodiment is simply a linear function of the distance in miles between the consumer and the vehicle. If the location of the consumer is not known specifically, the system may assign an estimated location, such as the center of a known region (e.g., zip code). In one embodiment, the distance between the consumer and vehicle locations in miles is multiplied by a corresponding weight for the distance category, translating the distance into a number of points. For instance, if the weight is −1.0, the number of (negative) points associated with the signal is the number of miles between the consumer at the vehicle. The greater the distance between the consumer and the vehicle, the lower the score will be for this category.

It should be noted that the specific scoring methodology for this factor is exemplary, and other methodologies, functions, etc. may be used in other embodiments. Similarly, the specific methodologies described below for the other factors are exemplary, and are intended to be illustrative of the different ways scores can be generated for the factors. Alternative embodiments may use these or other schemes or functions for generating scores for each of the factors.

The second consumer-facing category 320 in this embodiment is based on the price of the vehicle. In this embodiment, the signal used in the price category is a monthly payment (in dollars) that is calculated for the vehicle for the specific consumer. The monthly payment for a particular consumer may be calculated based on a number of factors, such as the consumer's income, rent, credit score, debt-to-income ratio, etc. Various different algorithms may be used to compute the consumer's expected monthly payment. The specific methodology used to calculate the monthly payment is beyond the scope of the present invention, so it will not be discussed in detail here.

In embodiments of the present invention, the price signal for a particular vehicle may be different for one consumer than it is for a different consumer because, for example, the different consumers may have different credit scores, incomes, etc. Since differences in the price are more significant with less-expensive vehicles and less significant with more expensive vehicles, the price category in one embodiment uses the log (logarithm base 10) of the price instead of a linear function to generate the corresponding price score. A difference of $20 will therefore be more significant for a monthly payment of around $200 than for a monthly payment of around $500. In an alternative embodiment, the total, raw price of the vehicle may be used instead of the consumer-specific monthly payment. The weight associated with the price category in this embodiment is negative, so that a higher price receives a lower score.

In one embodiment, the system generates the price score by taking the log (base 10) of the monthly price to get a raw signal. Then, the raw signal is multiplied by a negative weight (e.g., −175) to get the final price score (where a higher price is worse). For example, considering two cars from the same source, if Car A has a monthly price of $500, and Car B has a monthly price of $400:

Car A Price Score:−175*log(500)≈−472.3

Car B Price Score:−175*log(400)≈−455.4

It should be noted that the raw score itself is not of particular importance. Since the system is designed to rank the cars, it is the relative difference in scores that is of more importance. In this example, Car B has a 16.9 point advantage over Car A from this source.

The third consumer-facing category 330 in this embodiment represents whether the vehicle is a “good deal” (i.e., a “bargain”) for the consumer. The score for this category is computed based on signals that may include a “current fair value” of the vehicle, a start payment, and a monthly payment for the vehicle. The current fair value of the vehicle generally represents the value of a vehicle of the same type, characteristics and condition (e.g., make, model, year, mileage, etc.) as the vehicle for which the score is being generated. The fair value is determined based upon recent historical transactional data, and may take into account a number of factors, such as location, seasonality, and the like. The fair value of the vehicle may be determined in a variety of ways, some of which are described in more detail in U.S. Patent Application Pub. No. 2018/0204281. The score for the “good deal” category may be determined, for example, as the current fair value, minus the start payment, divided by the monthly payment. This is essentially the number of months it will take to pay the full value of the vehicle. The higher the score, the better. It should be noted that this is considered a consumer-facing category, even though the consumer is not presented with a specific number representing the “good deal” because it is based primarily on information that is presented to the client (start and monthly payments). In other embodiments, this could be considered a business-facing category.

An example of a good deal calculation follows. Consider that a vehicle is determined to be worth $10,000. If the start payment is $1,000 and the monthly payment is $300, then the good deal score would be (10000-1000)/300=30. As with the other scores, there is a weight associated with the good deal when they are added together. The weight for the good deal score may be 5, for example, so that the total points contribution for the good deal would be 5*30=150.

The business-facing categories in this embodiment correspond to whether the vehicle price is a good deal for the system operator (e.g., acquisition price divided by fair value), whether there is a reserved bonus (an incentive bonus associated with a dealer of the vehicle), and a dealer score (a measure of the responsiveness of the dealer of the vehicle). As noted above, the business-facing categories and associated values are not visible to the consumer, but they are significant to the operator of the system and are therefore taken into account in ranking the vehicles.

The first business-facing category 340 corresponds to whether the vehicle represents a good acquisition deal for the system operator. This is similar to the “good deal” category described above in the consumer-facing categories, in that it relates to the cost to acquire the vehicle. In this case, the total price for the vehicle is used instead of the price based on monthly payments. This price is typically available to the system operator through a dealer portal, and is sometimes less than the price at which the dealer will sell the vehicle to a consumer. The current fair value is divided by this total price to obtain the score for the category. A score of less than 1 is worse, and greater than 1 is better.

An example of the calculation of a good acquisition deal score follows. In this example, good acquisition deal score=(fair value/price), where “price” represents the price that the dealer has stated is their price to sell the car to the system operator. It is determined that Car A and Car B are each worth $10,000. A dealer is willing to sell Car A for $9,000 and Car B for $11,000. Then the good acquisition deal score for Car A would be 10,000/9,000=1.11, and the good acquisition deal score for Car B would be 10,000/11,000=0.909. The score is weighted before being added to the other scores. For instance, if the good acquisition deal weight is 30, the total contribution for the good acquisition deal score would be 33.3 for Car A and 27.3 for Car B.

The second business-facing category 350 in this embodiment corresponds to a “reserved bonus”. Some dealers, who may be referred to as “hub dealers” may agree to reserve some vehicles so that the dealers will sell these vehicles only through the automotive data processing system. This may be done to avoid situations in which a vehicle is available for sale through the automotive data processing system and also directly to a consumer through the dealership. In some cases, when a vehicle has been sold directly to a consumer through the dealership, the dealer may inadvertently fail to provide notification to the automotive data processing system that a vehicle has been sold. As a result, the vehicle may still be displayed by the system even though it is no longer available for sale. This may cause a number of problems. For instance, if the vehicle is selected by a consumer through the automotive data processing system and the consumer wishes to purchase or lease the vehicle, this transaction obviously cannot be completed, and the consumer is likely to be unhappy with this result. The automotive data processing system may therefore provide a bonus to dealers for vehicles that are reserved for sale only through the system. Since these reserved vehicles are only available through the automotive data processing system, it is assured that the vehicles will be available to any consumers that wish to purchase them. In one embodiment, the score for the reserved bonus category is simply a constant number of points for reserved vehicles (and no points for non-reserved vehicles).

The third business-facing category 360 in this embodiment corresponds to dealer responsiveness. The input signals for the dealer responsiveness category in one embodiment include a dealer response time and availability. When a consumer provides an indication to the operator of the automotive data processing system that they wish to purchase or subscribe to a vehicle, the system operator then contacts the dealer that owns the vehicle to finalize the transaction. For instance, the automotive data processing system may send a notification to a dealer computer that is connected to the system. The dealer must then respond to this notification so that the transaction can be completed. In one embodiment, this response may simply involve accepting or rejecting the transaction. The time that it takes for the dealer to reply to the notification of the system operator is used as an input for the dealer response category score. In some embodiments, the dealer has a predetermined period of time (e.g., 15 minutes) to respond to the system operator without penalty. After this period, points are accrued for each interval (e.g., each hour) thereafter. The system may be configured so that the dealer is not penalized for intervals outside of normal business hours. The longer the dealer takes to respond to the system operator, the higher the number of points. The other dealer responsiveness input signal in this embodiment relates to availability. If the system operator contacts the dealer to finalize a purchase of a vehicle and the vehicle is not available (e.g., the dealer sold the vehicle to another consumer but did not notify the system operator), the dealer is penalized. The dealer may get a certain number of points for each occurrence of a vehicle being unavailable. The dealer response time points and the availability points for the dealer are then added and multiplied by −1 to produce a dealer responsiveness score.

In one embodiment, each time a customer attempts to place an order to subscribe to a vehicle, the system confirms with the dealer that the vehicle is still in stock. The time it takes for the dealer to respond determines how many points the interaction is worth. In this embodiment, only response times during the open hours of the dealership are tracked. The following table provides an example of the points that are awarded based on the response time.

| Time to response (minutes) | Points |
|---|---|
| [0, 10] | +60 |
| (10, 30] | +30 |
| (30, 60] | +15 |
| (60, 240] | 0 |
| >240 | −25 |

All of the responses for a dealer are then averaged with the following caveats: responses from over 30 days ago but less than 60 days ago are given half importance; and any responses from over 60 days ago are not used. The score is then capped within a range of [0, 50]. Thus, a terrible dealership that averaged negative points would be given 0 points, and an excellent dealer with extremely fast responses could only have a maximum of 50 points.

Following is an example. In this example, a dealership has had response times of 5, 10, 21, 34 and 71 minutes over the past 30 days, and has had times of 9, 14, 18 and 34 in the past 31-60 days. In computing the weighted average, half the value of the 31-60 days is contributed in both the numerator and denominator. The dealer responsiveness score is therefore computed as:

$$Score = \frac{60 + 60 + 30 + 15 + 0 + 0.5 * ( 60 + 30 + 30 + 15 )}{6 + 0.5 * ( 4 )} = \frac{165 + ( 0.5 * 135 )}{6 + 2} = \frac{232.5}{8} = 29.06$$

In one embodiment, the scores for each of the dealers in the responsiveness category are updated on a daily basis. The intervals at which the scores are updated may vary in other embodiments. The scores in this category may be processed so that less weight is given to older scores. For example, scores within the last month may be given full weight, while scores between one and two months ago are given partial weight, and scores older than two months are given no weight. Thus, the scores reflect more recent activity and do not unduly penalize the dealers for older behavior.

As noted above, the scores for the different consumer-facing and business-facing categories are used in the ranking of vehicles that are presented to a consumer. The automotive data processing system may have hundreds of thousands, or even millions of records for different vehicles that may be viewed and purchased by a consumer. It may therefore, as a practical matter, be necessary to select a subset of these vehicles for processing and viewing by a consumer. This may, for example, be accomplished by initially selecting those vehicles which are located within a certain radius (e.g., 20 miles) of the consumer. The system may also enable the consumer to select filters which are then used to select the subset of vehicles. These filters may include distance, make, model, year, mileage, price range, or various other characteristics of the vehicles. After the subset of vehicles has been determined, the scores for the different consumer-facing and business-facing categories may be computed and used to rank the different vehicles within the selected subset.

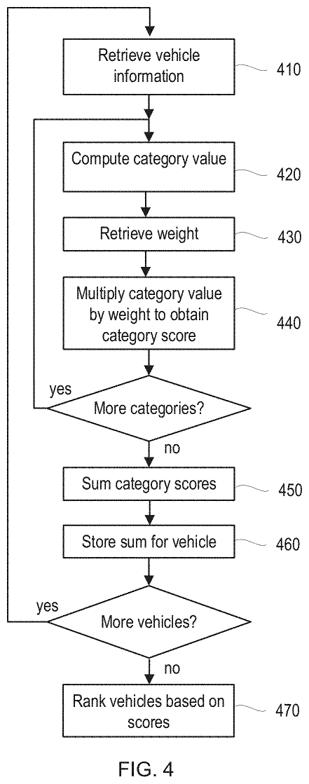

When the subset of vehicles has been identified, the scores in each of the categories described above are determined for each of the vehicles in the subset. An exemplary method for ranking the vehicles is illustrated in FIG. 4. As depicted in this figure, the information for the first vehicle in the subset is retrieved (410). For each category, the value of the corresponding factor is computed (420). For example, the value of the distance factor is computed by determining the distance in miles between the consumer and the vehicle location. A weight corresponding to this factor is then retrieved (430) from a current set (working set) of weights in a data store of the automotive data processing system. The weights for the respective factors may initially be determined in various ways, such as assignment by a system operator or even random assignment by the system. As the system is used, the weights may be adjusted, or tuned, as will be described in more detail below. The computed value for the factor is multiplied by the weight to determine a corresponding score for the factor (440). After the scores for each of the factors has been determined, the scores are summed to determine the total score associated with the vehicle (450). This total score is stored (460), and the procedure is repeated to determine a total score for each of the vehicles in the identified subset. After each of the vehicles has been scored, the vehicles are ranked based on the associated scores (470). This ranking can then be used to determine which vehicles are displayed to the user (or the order in which the vehicles are displayed).

When the vehicles are displayed to the user, the user's interaction with the system is tracked to identify the user's interest in one or more of the vehicles. This information is used in the tuning of the weights which are used to calculate vehicle scores and rank the vehicles. The user may indicate interest in a vehicle in several ways. For instance, the user may “tap” on a vehicle to view it, the user may “favorite” a vehicle (so that the vehicle can be easily viewed later), or the user may “subscribe” to a vehicle.

In one embodiment, the system tracks these actions for each user and, for each user, stores an associated list of vehicles that have been “tapped,” “favorited” or “subscribed”. These actions are interpreted as indicating interest in the corresponding vehicles. If a vehicle is neither “favorited” or “subscribed” (collectively “liked”) by the user, this is interpreted as an indication of no interest in the vehicle. In this embodiment, only vehicles that are “tapped” (viewed), “favorited”, or “subscribed” are included in the list associated with the user—vehicles that are not viewed by the user are not tracked.

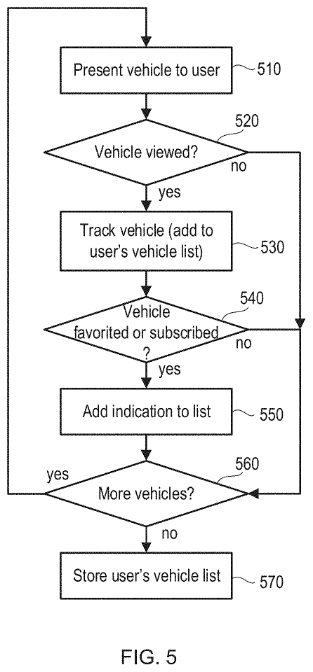

Referring to FIG. 5, a flow chart illustrating an exemplary method for generating a list of vehicles that have been viewed or liked by a user is shown. As depicted in this figure, a vehicle is presented to a user (510). This vehicle may be one of several that is displayed to a user via an interface of the automotive data processing system (e.g., an ordered list of vehicles that is generated by the ranking engine for display to the user). The system determines whether the vehicle has been viewed by the user (520). The user may have, for example, tapped on the vehicle to view detailed information for the vehicle. If the vehicle is not tapped (i.e., is not viewed by the user), the process continues, and if there are additional vehicles (560), these vehicles may be presented to the user (e.g., the user may be allowed to view additional vehicles in the ranked list). If a vehicle is viewed by the user (520), the vehicle is added to a list of vehicles associated with the user (530). If the user indicates that the vehicle is a favorite, or if the viewer subscribes to the vehicle (540), a corresponding indication will be added to the list to identify the vehicle as a favorite or subscribed vehicle (550). After the user finishes viewing the vehicle, if there are additional vehicles (560), they may be presented to the user to potentially be viewed, favorited, or subscribed. When the user has finished with the presented vehicles, the user's list of vehicles (which includes those vehicles which were reviewed, favorited or subscribed, but not those which were unviewed and unliked) is stored (570).

Thus, the system generates a set of lists (one for each user), where each list includes each vehicle that was “tapped”, “favorited”, or “subscribed” by the corresponding user. The list may have any suitable form or format for identifying a set of vehicles associated with a user. For each list, the system determines a score to indicate how well the ranking engine worked. Ideally, the ranking engine will have ranked the vehicles that were “favorited” or “subscribed” by the user positioned higher in the list than those vehicles that were “tapped”, but not “favorited” or “subscribed”. It should be noted that “list” is used here to refer to any stored grouping

The scoring of the user vehicle list may use many different functions. In one embodiment, a particular list is scored by ordering the vehicles in the list according to the order in which they were ranked by the ranking engine, then assigning points to each of the vehicles that was “tapped”, but not “favorited”, or “subscribed”. It should be noted that the user may have viewed the vehicles in the list in an order other than the order in which they were ranked, so the list may likewise have been created in an order other than the ranked order. In this embodiment, each of the vehicles in the list that is un-“favorited” and un-“subscribed” is assigned a number of points equal to the number of vehicles below it on the ranked list which were either “favorited” or “subscribed”. Thus, a “tapped” vehicle will have points if it was ranked higher than it should have been (i.e., it was ranked above a “favorited” or “subscribed” vehicle). “Favorited” and “subscribed” vehicles will have no points on the list. The points for all of the vehicles in the list are then summed to produce a score for the list.

Consider the example of a user who viewed four vehicles. These vehicles, when presented to the user, were ranked in a particular order. Vehicle #1 was the highest ranked vehicle, then vehicle #2 and vehicle #3, with vehicle #4 being the lowest ranked. Assume that the user “favorited” or “subscribed” vehicles #2 and #3, but not vehicles #1 and #4. Because vehicle #1 was not “favorited” or “subscribed”, the system assigns it one point for each of the “favorited” or “subscribed” vehicles in the list (i.e., vehicles #2 and #3). Vehicles #2 and #3 are not assigned any points because they were “favorited” or “subscribed”. Vehicle #4 is not assigned any points because there are no “favorited” or “subscribed” vehicles in the list below it. The points are shown in table 1 below. The total score for this list is therefore 2 points. Less than 2 points would indicate better performance by the ranking engine, while more than points would indicate worse performance.

TABLE 1

| vehicle | Favorited or subscribed | points |
|---|---|---|
| #1 | N | 2 |
| #2 | Y | 0 |
| #3 | Y | 0 |
| #4 | N | 0 |

As noted above, the vehicle list and the corresponding list score are associated with a particular individual user. A separate vehicle list is maintained for each user, and scores corresponding to each of these lists are generated. These vehicle lists and the associated scores are distinct from the factor or category scores that are generated for each particular vehicle and summed to generate corresponding ranking scores for the individual vehicles. As described below, however, the list scores can be used to modify (tune) the weights that are used to generate the vehicle scores on which the vehicle rankings are based.

The same scoring procedure is used for each of the lists (one for each user), and the sum of the scores for all of the lists is used as an indicator of how well the ranking engine performed. This aggregate score is associated with the current working set of weights that were used to score and rank the vehicles for presentation to the users. The system can then perform a tuning procedure in which the weights associated with the different consumer-facing and business-facing factors are varied, and the performance score associated with each set of weights is determined (by determining what the aggregate score would have been if the vehicle rankings presented to the users had been determined according to these weights).

The performances of the ranking engine corresponding to the different sets of weights are then compared, and the weight set with the best performance can be selected as a new working set. “Best” is used here to refer to the performance which, in the aggregate, generates vehicle rankings which most closely match the interest shown by users in their interactions with the system. Using a scoring scheme as described above with respect to Table 1, the best performance would correspond to the set of weights that resulted in the lowest combined scores for the vehicle lists of all the users.

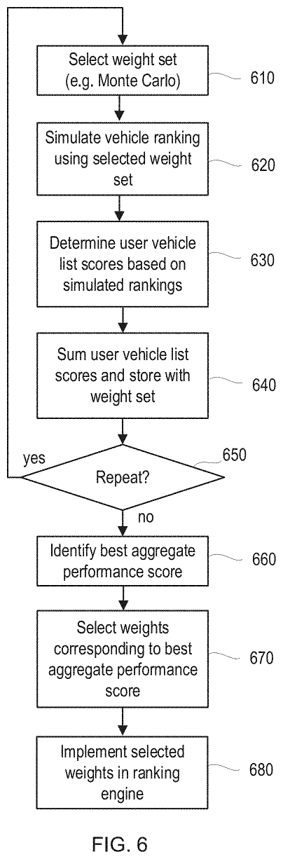

Referring to FIG. 6, an exemplary procedure for tuning the ranking engine (i.e., adjusting the weights used by the ranking engine in association with each of the consumer-facing and business-facing factors) is illustrated. It is assumed that the performance of the ranking engine using the current set of weights has been determined, and that an indication of this performance has been stored for comparison to alternative weight sets.

After the performance of the current weight set has been determined, a new set of weights for the ranking factors is selected to be tested (610). The selection of the new weights may be accomplished in a variety of ways. In one exemplary embodiment, the weights for each of the factors are randomly selected from a predetermined range using a Monte Carlo technique. In this embodiment, it is anticipated that many (e.g., 10,000) different tentative sets of weights will be considered and simulated, so while some of the sets may have performance which is significantly worse than the current working set of weights, some of the tested sets of weights may improve upon this performance. In alternative embodiments, the alternative weight sets may be selected using any suitable methodology (e.g., making small deviations from the existing working set of weights).

After a set of weights has been selected, the system simulates the vehicle rankings using this selected set of weights (620). The ranking of the vehicles will use the same factors described above in connection with FIG. 4, but will use the selected weights instead of the current working set of weights. After this new vehicle ranking is generated, the system will determine the performance of the selected set of weights by recomputing a score for each user's list of tapped/favorited/subscribed vehicles, as described above in connection with FIG. 4 and Table 1. Because the selected set of weights may have resulted in a different ranking of the vehicles, each user's list may be re-ordered, and the resulting list scores may change in comparison to the scores resulting from the original vehicle ranking. For example, if the vehicles identified in Table 1 were re-ranked so that vehicles #1 and #2 are switched, the scores for these vehicles would be as shown below in Table 2. Because the positions of vehicles #1 and #2 are reversed, the total score for the four vehicles in this list is 1 point instead of 2 points. Thus, the newly selected set of weights provides better performance with respect to the list of this particular user.

TABLE 2

| vehicle | Favorited or subscribed | points |
|---|---|---|
| #2 | Y | 0 |
| #1 | N | 1 |
| #3 | Y | 0 |
| #4 | N | 0 |

As noted above, the overall performance of a particular set of weights is determined based upon the scores associated with all of the users, rather than a single user. While the selected set of weights may improve the performance of the ranking engine with respect to the user associated with the vehicles listed in Tables 1 and 2, it may worsen (or improve, or have no effect on) the performance of the ranking engine with respect to other users. Therefore, performance scores are generated for each of the users' lists (630), and the scores are added to produce an overall (aggregate) score for the set of weights, and this score is stored in association with the set of weights (640). This procedure may be repeated for a predetermined number of cycles (650) so that performance scores are determined for a number of different weights sets. After the scores are determined for each of these different weights sets, the scores are compared to determine which of the weight sets has the best performance score (660). In the example above, this would be the lowest score, but alternative embodiments may use performance scoring schemes in which higher scores indicate better performance. When the best score has been identified, the corresponding set of weights is selected (670), and these weights are stored as a new working set that will be implemented in the ranking engine (680). Accordingly, these weights will be used in subsequent rankings of vehicles that are presented to the users.

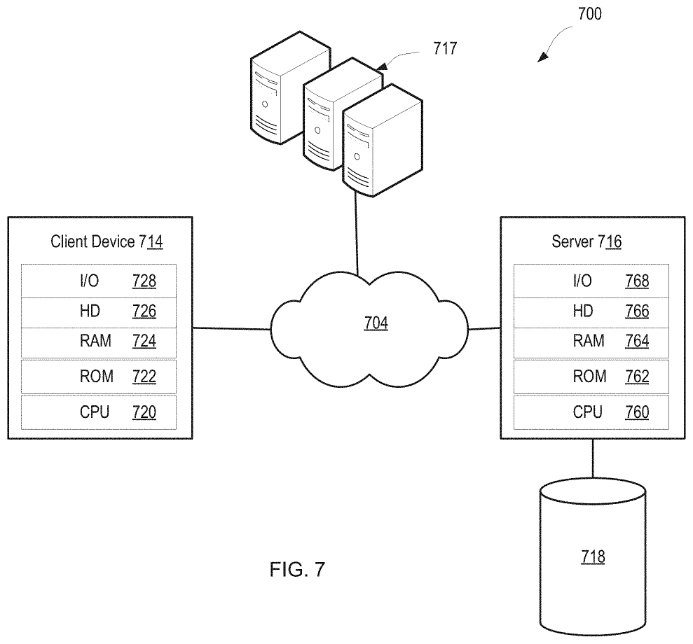

FIG. 7 depicts a diagrammatic representation of a distributed network computing environment where embodiments disclosed can be implemented. In the example illustrated, network computing environment 700 includes network 704 that can be bi-directionally coupled to a client computing device 714, a server system 716 and one or more third party systems 717. Server system 716 can be bi-directionally coupled to data store 718. Network 704 may represent a combination of wired and wireless networks that network computing environment 700 may utilize for various types of network communications known to those skilled in the art.

For the purpose of illustration, a single system is shown for each of client computing device 714 and server system 716. However, a plurality of computers may be interconnected to each other over network 704. For example, a plurality client computing devices 714 and server systems 716 may be coupled to network 704.

Client computer device 714 can include central processing unit (“CPU”) 720, read-only memory (“ROM”) 722, random access memory (“RAM”) 724, hard drive (“HD”) or storage memory 726, and input/output device(s) (“I/O”) 728. I/O 728 can include a keyboard, monitor, printer, electronic pointing device (e.g., mouse, trackball, stylus, etc.), or the like. In one embodiment I/O 728 comprises a touch screen interface and a virtual keyboard. Client computer device 714 may implement software instructions to provide a client application configured to communicate with an automotive data processing system. Likewise, server system 716 may include CPU 760, ROM 762, RAM 764, HD 766, and I/O 768. Server system 716 may implement software instructions to implement a variety of services for an automotive data processing system. These services may utilize data stored in data store 718 and obtain data from third party systems 717. Many other alternative configurations are possible and known to skilled artisans.

Each of the computers in FIG. 7 may have more than one CPU, ROM, RAM, HD, I/O, or other hardware components. For the sake of brevity, each computer is illustrated as having one of each of the hardware components, even if more than one is used. Each of computers 714 and 716 is an example of a data processing system. ROM 722 and 762; RAM 724 and 764; HD 727, and 766; and data store 718 can include media that can be read by CPU 720 or 760. Therefore, these types of memories include non-transitory computer-readable storage media. These memories may be internal or external to computers 714 or 716.

Portions of the methods described herein may be implemented in suitable software code that may reside within ROM 722 or 762; RAM 724 or 764; or HD 727 or 766. The instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

Any suitable programming language can be used to implement the routines, methods or programs of embodiments of the invention described herein. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved by distributed or networked systems. Communication or transfer (or otherwise moving from one place to another) of data may be wired, wireless, or by any other means.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited only those elements but may include other elements not expressly listed or inherent to such process, article, or apparatus. Further, unless expressly stated to the contrary, “or” refers to an inclusive or and not to an exclusive or. For example, a condition “A or B” is satisfied by any one of the following: A is true (or present) and B is false (or not present), A is false (or not present) and B is true (or present), and both A and B are true (or present).

To the extent particular values are provided in any example embodiments in the description, such values are provided by way of example and not limitation. Moreover, while in some embodiments rules may use hardcoded values, in other embodiments rules may use flexible values. In one embodiment, one or more of the values may be specified in a registry, allowing the value(s) to be easily updated without changing the code. The values can be changed, for example, in response to analyzing system performance.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A method for tuning a set of weights for a ranking engine in an automotive data processing system, the method comprising:
tracking user interactions with an automotive data processing system;
identifying, for each of a plurality of users, a corresponding list of vehicles in which the user has indicated interest through the user interactions;
for each of a plurality of weight sets, wherein each weight set includes a weight corresponding to each of a plurality of ranking factors,
ranking, for each of the plurality of users, the vehicles in the corresponding list of vehicles using the weight set,
generating, for each list of vehicles, a corresponding ranking score,
generating an aggregate performance score based on the ranking scores for the lists of vehicles, and
storing the aggregate performance score with an indication of the corresponding weight set;
comparing the aggregate performance scores corresponding to the plurality of weight sets;
identifying a weight set that has a best corresponding performance; and
implementing the identified weight set as a working weight set for the ranking engine.

2. The method of claim 1, wherein the ranking factors include one or more consumer-facing factors which are based on information that is visible to users of the automotive data processing system and one or more business-facing factors which are based on information that is not visible to users of the automotive data processing system.

3. The method of claim 2, wherein the consumer-facing factors include at least a price factor and a location factor.

4. The method of claim 3, wherein the business-facing factors include one or more of: a deal value factor, a reserved vehicle factor, and a dealer responsiveness factor.

5. The method of claim 1, further comprising the automotive data processing system presenting to each of the users a plurality of vehicles; wherein, for each of the plurality of users, identifying the vehicles in the corresponding list of vehicles comprises identifying vehicles that the user has either viewed or liked; wherein tracking user interactions comprises, for each user, determining whether each of the vehicles in the corresponding list of vehicles has been either viewed or liked by the user and storing an indication of the vehicle and whether the vehicle has been viewed or liked by the user.

6. The method of claim 5, wherein the list of vehicles corresponding to each user excludes vehicles that have been neither viewed nor liked by the user.

7. The method of claim 6, wherein the ranking score for each list of vehicles is generated by: for each non-liked vehicle in the list, assigning to the non-liked vehicle a point for each liked vehicle in the list which is ranked below the non-liked vehicle; and summing the points for all of the non-liked vehicles in the list of vehicles.

8. The method of claim 7, wherein the aggregate performance score for each of the plurality of weight sets is generated by summing the corresponding ranking scores for all of the lists of vehicles.

9. The method of claim 5, further comprising; ranking, by the ranking engine, the plurality of vehicles; and presenting, by the automotive data processing system, the plurality of vehicles according to the ranking of the plurality of vehicles.

10. The method of claim 1, further comprising, prior to tracking the user interactions with the automotive data processing system, generating a ranking of all of the plurality of vehicles based on a current working weight set, wherein the current working weight set is included in the plurality of weight sets.

11. An automotive data processing system comprising:
one or more processors communicatively coupled to one or more data storage devices, the one or more processors coupled to a non-transitory computer-readable medium that stores instructions which are executable by the processor to cause the processor to perform:
tracking user interactions with an automotive data processing system;
identifying, for each of a plurality of users, a corresponding list of vehicles in which the user has indicated interest through the user interactions;
for each of a plurality of weight sets, wherein each weight set includes a weight corresponding to each of a plurality of ranking factors,
ranking, for each of the plurality of users, the vehicles in the corresponding list of vehicles using the weight set,
generating, for each list of vehicles, a corresponding ranking score,
generating an aggregate performance score based on the ranking scores for the lists of vehicles, and
storing the aggregate performance score with an indication of the corresponding weight set;
comparing the aggregate performance scores corresponding to the plurality of weight sets;
identifying a weight set that has a best corresponding performance; and
implementing the identified weight set as a working weight set for the ranking engine.

12. The automotive data processing system of claim 11, wherein the ranking factors include one or more consumer-facing factors which are based on information that is visible to users of the automotive data processing system and one or more business-facing factors which are based on information that is not visible to users of the automotive data processing system.

13. The automotive data processing system of claim 12, wherein the consumer-facing factors include at least a price factor and a location factor; and wherein the business-facing factors include one or more of a deal value factor, a reserved vehicle factor, and a dealer responsiveness factor.

14. The automotive data processing system of claim 11, further comprising the automotive data processing system presenting to each of the users a plurality of vehicles; wherein, for each of the plurality of users, identifying the vehicles in the corresponding list of vehicles comprises identifying vehicles that the user has either viewed or liked; wherein tracking user interactions comprises, for each user, determining whether each of the vehicles in the corresponding list of vehicles has been either viewed or liked by the user and storing an indication of the vehicle and whether the vehicle has been viewed or liked by the user.

15. The automotive data processing system of claim 14, wherein the list of vehicles corresponding to each user excludes vehicles that have been neither viewed nor liked by the user; wherein the ranking score for each list of vehicles is generated by: for each non-liked vehicle in the list, assigning to the non-liked vehicle a point for each liked vehicle in the list which is ranked below the non-liked vehicle; and summing the points for all of the non-liked vehicles in the list of vehicles; and wherein the aggregate performance score for each of the plurality of weight sets is generated by summing the corresponding ranking scores for all of the lists of vehicles.

16. A computer program product for generating vehicle encodings, the computer program product comprising a non-transitory computer-readable medium storing instructions executable by a processor to cause the processor to perform:
tracking user interactions with an automotive data processing system;
identifying, for each of a plurality of users, a corresponding list of vehicles in which the user has indicated interest through the user interactions;
for each of a plurality of weight sets, wherein each weight set includes a weight corresponding to each of a plurality of ranking factors,
ranking, for each of the plurality of users, the vehicles in the corresponding list of vehicles using the weight set,
generating, for each list of vehicles, a corresponding ranking score,
generating an aggregate performance score based on the ranking scores for the lists of vehicles, and
storing the aggregate performance score with an indication of the corresponding weight set;
comparing the aggregate performance scores corresponding to the plurality of weight sets;
identifying a weight set that has a best corresponding performance; and
implementing the identified weight set as a working weight set for the ranking engine.

17. The computer program product of claim 16, wherein the ranking factors include one or more consumer-facing factors which are based on information that is visible to users of the automotive data processing system and one or more business-facing factors which are based on information that is not visible to users of the automotive data processing system.

18. The computer program product of claim 17, wherein the consumer-facing factors include at least a price factor and a location factor; and wherein the business-facing factors include one or more of a deal value factor, a reserved vehicle factor, and a dealer responsiveness factor.

19. The computer program product of claim 16, further comprising the automotive data processing system presenting to each of the users a plurality of vehicles; wherein, for each of the plurality of users, identifying the vehicles in the corresponding list of vehicles comprises identifying vehicles that the user has either viewed or liked; wherein tracking user interactions comprises, for each user, determining whether each of the vehicles in the corresponding list of vehicles has been either viewed or liked by the user and storing an indication of the vehicle and whether the vehicle has been viewed or liked by the user.

20. The computer program product of claim 19, wherein the list of vehicles corresponding to each user excludes vehicles that have been neither viewed nor liked by the user; wherein the ranking score for each list of vehicles is generated by: for each non-liked vehicle in the list, assigning to the non-liked vehicle a point for each liked vehicle in the list which is ranked below the non-liked vehicle; and summing the points for all of the non-liked vehicles in the list of vehicles; and wherein the aggregate performance score for each of the plurality of weight sets is generated by summing the corresponding ranking scores for all of the lists of vehicles.
